(19) United States
(12) Patent Application Publication
(10) Pub. No.: US 2008/0085041 A1
(43) Pub. Date: Apr. 10, 2008

(54) Method Of Geometrical Distortion Correction In 3D Images

(75) Inventor: Marcel Breeuwer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,950

(22) PCT Filed: Nov. 16, 2005
(86) PCT No.: PCT/IB05/53782

§ 371 Date: May 23, 2007

(30) Foreign Application Priority Data
Nov. 29, 2004 (EP) 04106129.2

(51) Int. Cl. G06K 9/00; G06K 9/40

(52) U.S. Cl. 382/128; 382/154; 382/275

(57) ABSTRACT

A method of correcting local distortions in 3D images, particularly medical 3D images, caused by a scanning system used for acquisition of the 3D images, is disclosed. According to an embodiment, a 3D phantom containing reference structures that are positioned at known reference positions is scanned. Then the resulting positions of the phantom reference structures in the 3D image are detected and the 3D image is subdivided into 3D sub-volumes, called patches. Subsequently the detected positions of the reference structures are compared to the known reference positions for each patch, and for each patch having distortions existing between known reference and detected positions, the distortion is described with a local 3D transformation according to the invention. Finally, medical images that are subsequently scanned are corrected with the local 3D transformations.

This invention pertains in general to the field of 3-dimensional (3D) images, particularly 3D medical images. More particularly the invention relates to the correction of geometrical distortions in such 3D images.

Three-dimensional Magnetic Resonance (3D MR) images acquired by MR scanners are widely used for diagnosis, for planning of treatment, during the actual treatment and for monitoring the effect of treatment. These images may however contain scanner-induced geometric distortion due to inhomogeneity in the static magnetic field and imperfections in the magnetic field gradients, and patient-induced geometric distortion, e.g. due to chemical shift, magnetic susceptibility and flow artifacts. For qualitative diagnosis, geometric errors in the order of a few millimeters are often tolerated. However, quantitative applications such as image-guided neurosurgery and radiotherapy can require a geometric accuracy of a millimeter or better. It is known that especially 3D MR images may contain the scanner-induced type of distortion due to inhomogeneity in the constant magnetic field (B₀) and/or due to imperfect magnetic gradient fields (Gₓ, G_{y}, G_{z}).

The use of a phantom to measure this distortion and an algorithm to globally correct for this distortion has been disclosed in M. Breeuwer et al. “Detection and correction of geometric distortion in 3D MR images”, Proceedings SPIE Medical Imaging 2001, Vol. 4322, pages 1110-1120. The geometrical distortion correction method described in this disclosure is suited for images that contain only a limited amount of distortion, i.e. several mm, that varies only slowly as a function of the position in the 3D image, i.e. for a slowly varying, continuous distortion field. For 3D images with a large amount of more local distortion, the disclosed method is not well suited. Such local distortions are for instance present in certain types of MR images.

Soimu et al discloses in “A novel approach for distortion correction for X-ray image intensifiers” a global transformation technique that is combined with subsequent local 2D transformations in slices of 3D images. The local 2D transformations are fixed, i.e. the same transformation is used at different locations. Moreover, the local 2D transformations are performed after a preceding global 3D transformation of the same image, which has several disadvantages. Firstly, applying first a global and then a local transformation is more complex. Secondly, the application of a global 3D transformation may enlarge the local distortions, which may mean that it is more difficult to find the appropriate local transformation or that finding this local transformation becomes more complex. Furthermore, the local 2D transformations disclosed use rectangular subsets of reference points in an image, also called “patches”. However, the patches disclosed in Soimu et al are of a predefined fixed patch size. Hence, the disclosed method is not flexible to different local distortions occurring in an image, and further it is not well suited for the correction of local distortions in 3D images. Thus, there is a need for a new method for correcting local geometrical distortion in 3D medical images.

Hence, the problem to be solved by the invention is to provide an effective and more flexible distortion correction for a 3D image having local distortions within the 3D image.

Accordingly, the present invention preferably seeks to mitigate, alleviate or eliminate one or more of the above-identified deficiencies in the art and disadvantages singly or in any combination and solves at least the above mentioned problems by providing a method, a medical imaging system, a computer readable medium and a medical examination apparatus according to the appended patent claims.

The general solution according to the invention is to only use 3D local transformations for distortion correction of geometrical distortions in 3D images, such as medical 3D images, preferably having only local and not global distortions, in such a way that correct measurements are enabled within these 3D images. The local 3D transformations are preferably obtained from scanning a well-defined 3D phantom with a 3D scanning system of the above mentioned kind producing 3D images. The distortion correction thus minimizes scanner-induced distortions.

According to one aspect of the invention, a method of distortion correction of local distortions in a 3D image is provided. The method comprises the step of correcting at least one distorted 3D sub-volume in the 3D image with at least one corresponding local 3D transformation, such that at least one local distortion in said at least one 3D sub-volume is locally corrected by the local 3D transformation.

According to an embodiment of the invention, the method comprises further the steps of:

a) scanning a 3D phantom to a 3D image, said phantom containing reference structures that are positioned at known reference positions,

b) detecting the positions of the phantom reference structures in the 3D image resulting from step a),

c) subdividing the 3D image into a plurality of 3D patches;

d) comparing the detected positions of the reference structures to the known reference positions for each patch,

e) for each patch having distortions existing between known reference and detected positions, describing each distortion with a local 3D transformation, and

f) correcting images that are subsequently scanned with the same scanning protocol as in step a), with the local 3D transformations from step e).

Preferably the 3D image is a medical 3D image, particularly a 3D MR image.

According to another aspect of the invention, a medical imaging system is provided. The medical imaging system is adapted to distortion correction of local distortions in medical 3D images and comprises means f) for correcting distorted sub-volumes in the 3D image with at least one corresponding local 3D transformation, such that distortions in said 3D sub-volumes are locally corrected by said local 3D transformation.

According to an embodiment, the medical imaging system comprises furthermore:

a) means for scanning a 3D phantom containing reference structures that are positioned at known reference positions,

b) means for detecting the positions of the phantom reference structures in the 3D image scanned by the scanning means a),

c) means for subdividing the 3D image into a plurality of 3D sub-volumes;

d) means for comparing the detected positions of the reference structures to the known reference positions for each sub-volume,

e) means for describing each distortion with a local 3D transformation for each sub-volume having distortions existing between known reference and detected positions, and

wherein said means f) are configured to correct at least one 3D image that is subsequently imaged with the local 3D transformations from step e), and wherein said means a)-f) are operatively connected to each other.

According to a further aspect of the invention, a computer-readable medium having embodied thereon a computer program for processing by a computer is provided. The computer program comprises code segments for distortion correction of local distortions in 3D images comprising a code segment for correcting at least one distorted 3D sub-volumes in the 3D image with at least one corresponding local 3D transformation, such that distortions in said 3D sub-volumes are locally corrected by said local 3D transformation.

According to an embodiment, the computer-readable medium further comprises:

a) a code segment for scanning a 3D phantom containing reference structures that are positioned at known reference positions,

b) a code segment for detecting the positions of the phantom reference structures in the 3D image scanned by code segment a),

c) a code segment for subdividing the 3D image into a plurality of 3D sub-volumes;

d) a code segment for comparing the detected positions of the reference structures to the known reference positions for each sub-volume,

e) a code segment for describing each distortion with a local 3D transformation for each sub-volume having distortions existing between known reference and detected positions, and wherein said code segment f) is configured to correct at least one 3D image that is subsequently imaged with the local 3D transformations from step e).

According to yet another aspect of the invention, a medical examination apparatus is provided that is arranged for implementing the above-mentioned distortion correction method. Preferably, the medical examination apparatus is a medical imaging workstation having measurement functionality.

The present invention has the advantage over the prior art that it allows for more accurately correcting very local distortions, which cannot be optimally done with a global correction approach. The invention enables correction of very local distortions in medical 3D images such as MR images. Furthermore, the invention provides greater flexibility than global approaches, as different regions in an image/volume may be handled differently.

Further objects, features and advantages of the invention will become apparent from the following description of embodiments of the present invention, reference being made to the accompanying drawings, in which:

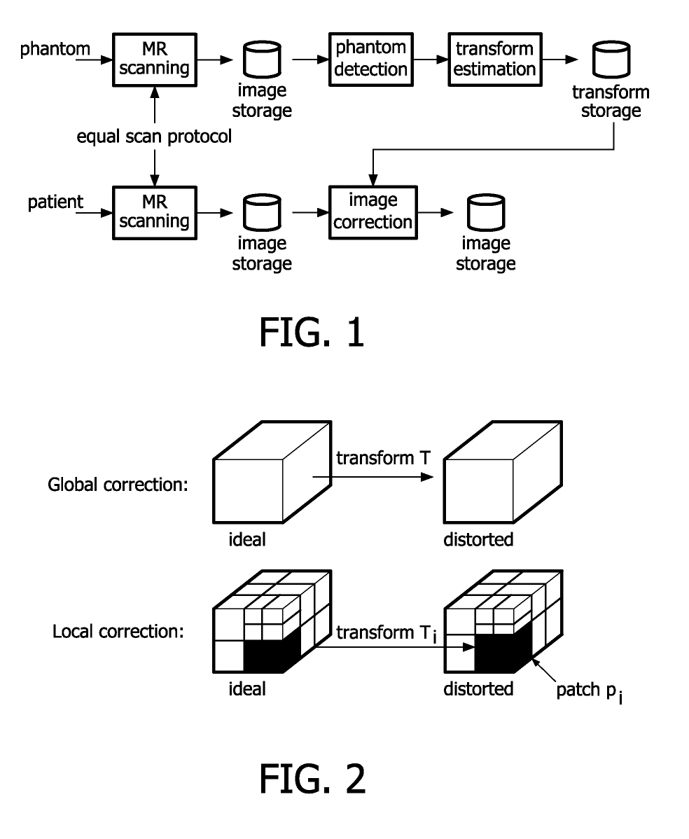

FIG. 1 is a schematic illustration of a prior art global transformation of medical 3D images;

FIG. 2 is a schematic illustration of global 3D transformations and local 3D transformations;

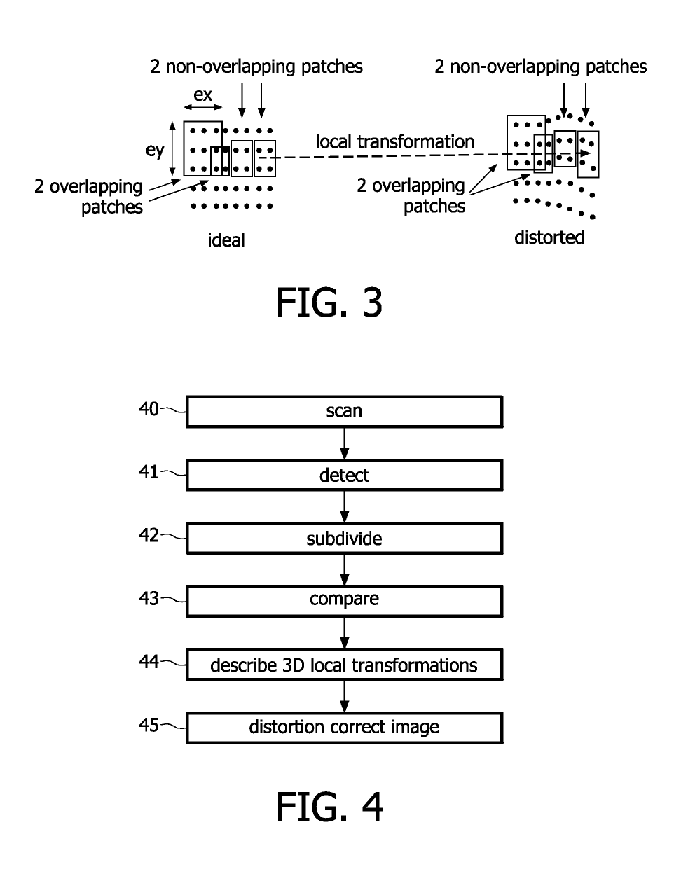

FIG. 3 is a schematic illustration of 2D patches and local transformations; and

FIG. 4 is a flowchart illustrating an embodiment of the method according to the present invention.

The prior art method of global distortion correction of M. Breeuwer et al. described above consists of the following steps:

a) scanning a 3D phantom containing reference structures (e.g. spheres) that are positioned at exactly known positions, wherein this step is also called “phantom scanning”,

b) detecting the positions of the phantom reference structures in the 3D image resulting from the phantom scan wherein this step is also called “phantom detection”,

c) comparing the detected positions of the reference structures to their ideal, i.e. undistorted, positions and describe the distortion between ideal and detected positions with a higher-order 3D polynomial transformation, wherein this step is also called “transform estimation”, and

d) correcting patient images that are later on scanned, and more precisely with exactly the same protocol as used during phantom scanning, with the calculated higher-order polynomial transformation, wherein this step is also called “image correction” or “distortion correction”.

FIG. 1 gives a block diagram of the above described global distortion correction method. For more details the reader is referred to the disclosure of Breeuwer et al., which herewith is incorporated by reference.

In a method of local distortion correction according to an embodiment of the present invention, the distortion between the ideal and detected reference positions is in contrast to the above described prior art method described using a set of local 3D transformations. The number of transformations, their order (in the case of a polynomial transformation) and their extent in 3D may automatically be adapted to the amount and type of distortion present in the 3D image. Of course, the set must be chosen in such a way that it completely covers the 3D image space. FIG. 2 illustrates this idea and is described in more detail below.

Estimating Local Correction Transformations

More precisely, the method of local distortion correction according to the present embodiment is implemented with exemplary rectangular subsets of reference points, which will henceforth be called patches.

A patch pᵢ, where i indicates the number of the patch in the list of all patches, consists of Nᵢ reference points and each of these reference points has a known position xⱼ=(xⱼ, yⱼ, zⱼ), j=1, . . . , Nᵢ in the phantom. The phantom defines the ideal, undistorted 3D space.

A position uⱼ=(uⱼ, vⱼ, wⱼ) corresponding to position xⱼ is found in the image, i.e. in the real, 3D space distorted by the imaging characteristics of the scanner.

Furthermore, a patch pᵢ has an extent eᵢ=(exᵢ, eyᵢ, ezᵢ) in the phantom space, i.e. eᵢ specifies the volume that the patch pᵢ covers in 3D space, and it has an operational area oᵢ=(oxᵢ, oyᵢ, ozᵢ) i.e. oᵢ specifies the volume in the 3D space in which it will be used for distortion correction. The operational area oⱼ will always be smaller than or equal to the extent eᵢ.

Moreover, patches may overlap, i.e. reference points may be used in more than one patch, see FIG. 3. This helps to create continuity between the local transformations of neighboring patches.

According to the embodiment, a local distortion correction transformation Tᵢ is estimated for each of the patches pᵢ.

The estimation of a local distortion correction transformation Tᵢ may be based on the same estimation method as described in the above referenced global transformation disclosure of Breeuwer et al. In this case, the degree Dᵢ of the polynomial transformation may be varied from patch to patch in order to take the specific characteristic of the patches local distortions into consideration. In practice, the degree will be limited by the number of reference points included in the patch, as the transform estimation cannot determine more transform parameters than 3 times the number of reference points as the transform estimation is basically a parameter estimation problem; it is in principle not possible to estimate more parameters than the number of measurements made.

FIG. 3 illustrates the idea of patches and local transformations for a 2D space, the same principle however, may be applied in 3D. The bottom part of FIG. 2 already explains the idea of 3D patches and local transform in the case the patches do not overlap. A drawing of overlapping 3D patches is of illustrative purposes difficult to make, and therefore, the idea of overlapping patches is illustrated in the 2D space scenario given in FIG. 3. However, 3D patches comprise reference points in a volume of a 3D image, in contrast to 2D patches comprising reference points in an area of a 2D image. Hence, overlapping 3D patches have the characteristics of partly overlapping volumes sharing reference points between several 3D patches.

The parameters Nᵢ, Dᵢ, eᵢ, and oⱼ have to be determined. In principle, this may be performed fully automatically, in such a way that the distortion is optimally corrected, i.e. resulting in the least amount of remaining distortion after correction. Various measures can be used to characterize the remaining distortion: the root mean square error (3D Euclidian distance) between corrected and ideal positions, the maximum error between corrected and ideal positions, the mean error . . . etc.

According to one example, a computer program calculates the overall remaining distortion as a function of all possible values of these parameters, so that when all calculations are finalized the best parameter values are chosen. According to another example, needing less computational power, the parameters Nᵢ, eᵢ, and oᵢ are given fixed values, so that the distortion is only minimized for the polynomial degree Dᵢ.

Flexibility with regard to the region of interest of the transformations is given by the flexible use of patches, as explained above, i.e. overlapping patches, varying patch shape and patch size etc.

The above method is illustrated in FIG. 4, starting with scanning a 3D phantom to a 3D image in step 40. In step 41 the positions of the phantom reference structures in the 3D image resulting from step 40 are detected. Subsequently, the 3D image is subdivided into a plurality of 3D patches in step 42. Then, in step 43, the detected positions of the reference structures are compared to the known reference positions for each patch. Further, for each patch having distortions existing between known reference and detected positions, each distortion is in step 44 described with a local 3D transformation, and finally, in step 45, images that are subsequently scanned with the same scanning protocol as in step 40, are distortion corrected with the local 3D transformations derived in step 44.

Applications and use of the above described method and system for correcting distortions in 3D medical images according to the invention are various and include exemplary fields such as image-guided surgery, image-guided biopsy and image-guided radiation therapy.

The invention is especially applicable to 3D MR images resulting from scanning protocols that generate a significant amount of local geometrical distortion.

However, the method is generally applicable on any 3D image that contains distortion, which can be measured by imaging a phantom with well-defined reference points/structures, i.e. also to non-medical images.

The present invention has been described above with reference to specific embodiments. However, other embodiments than the preferred above are equally possible within the scope of the appended claims, e.g. different local 3D transformations, e.g. 3D splines, than those described above, performing the above method by hardware or software, etc.

Furthermore, the term “comprises/comprising” when used in this specification does not exclude other elements or steps, the terms “a” and “an” do not exclude a plurality and a single processor or other units may fulfill the functions of several of the units or circuits recited in the claims.

1. A method of distortion correction of local distortions in a 3D image, preferably a 3D medical image, comprising the step of performing at least one local 3D transformation on at least one distorted 3D sub-volume in the 3D image, such that at least one local distortion in said at least one 3D sub-volume being locally corrected by said local 3D transformation.

2. The method according to claim 1, wherein said 3D-image is part of a series of 3D-images taken subsequently, further comprising, prior to said step of locally transforming, the steps of:
subdividing a first 3D image of the series into a plurality of 3D sub-volumes comprising said at least one distorted 3D sub-volume in the 3D image,
for at least one, preferably each, 3D sub-volume having at least one distortion existing between at least one known reference and a corresponding detected position, describing at least one of said distortions with a local 3D transformation for the such distorted 3D sub-volume,
wherein said local 3D transformation being performed on at least one corresponding 3D sub-volume in a second 3D image of the series, subsequent to said first 3D image.

3. The method according to claim 2, for identifying distorted 3D sub-volumes, further comprising, prior to said step of describing distortions, the steps of:
detecting positions from of at least one reference structure in the 3D image corresponding to said reference positions, and
determining if a 3D sub-volume has said at least one distortion existing between at least one known reference and a corresponding detected position by comparing said detected positions of the at least one reference structure to the known reference positions of said reference structure in said 3D image for each of said 3D sub-volumes, wherein a 3D sub-volume being considered distorted if said step of comparing results in differences between the reference and corresponding detected position.

4. The method according to claim 2, wherein said step of subdividing results in at least two of said 3D sub-volumes having a different size, volume and/or shape in the 3D image space, further comprising the step of automatically choosing an optimal size, volume and/or shape for at least one of said 3D sub-volumes, such that the least amount of remaining distortion results after the step of local 3D transformation for the at least one of said 3D sub-volumes.

5. The method according to claim 1, wherein at least two 3D sub-volumes are at least partly overlapping each other, such that optimal local 3D transformations being performed for specific distorted 3D images by creating continuity between local 3D transformations of neighboring 3D sub-volumes.

6. The method according to claim 1, comprising the step of automatically choosing an optimal local 3D transformation for at least one of said 3D sub-volumes, such that the least amount of remaining distortion results after the step of local 3D transformation for the at least one of said 3D sub-volumes.

7. The method according to claim 6, wherein the local 3D transformation being a polynomial transformation, and said step of automatically choosing an optimal local 3D transformation comprising varying the degree of the polynomial transformation between different 3D sub-volumes, considering specific characteristic of the 3D local distortions.

8. A medical imaging system being adapted to distortion correction of at least one local distortion in a medical 3D image comprising means for performing at least one local 3D transformation on at least one distorted 3D sub-volume in the 3D image, such that at least one local distortion in said at least one 3D sub-volume being locally corrected by said local 3D transformation.

9. The system according to claim 8, further comprising:
means for scanning a 3D phantom containing reference structures that are positioned at known reference positions,
means for detecting the positions of the phantom reference structures in the 3D image scanned by the scanning means),
means for subdividing the 3D image into a plurality of 3D sub-volumes;
means for comparing the detected positions of the reference structures to the known reference positions for each sub-volume,
means for describing each distortion with a local 3D transformation for each sub-volume having distortions existing between known reference and detected positions, and wherein
said means for performing at least one local 3D transformation are configured to correct at least one 3D image that is subsequently imaged by the local 3D transformations, and
wherein
said means are operatively connected to each other.

10. The system according to claim 8, wherein said system is a Three-dimensional Magnetic Resonance scanner adapted to perform the method of distortion correction of local distortions in a 3D image, preferably a 3D medical image, comprising the step of performing at least one local 3D transformation on at least one distorted 3D sub-volume in the 3D image, such that at least one local distortion in said at least one 3D sub-volume being locally corrected by said local 3D transformation.

11. A computer-readable medium having embodied thereon a computer program for processing by a computer, the computer program comprising code segments for distortion correction of local distortions in a 3D image comprising a code segment for performing at least one local 3D transformation on at least one distorted 3D sub-volume in the 3D image, such that at least one local distortion in said at least one 3D sub-volume being locally corrected by said local 3D transformation when executed by said computer.

12. The computer-readable medium according to claim 11, further comprising:
a code segment for scanning a 3D phantom containing reference structures that are positioned at known reference positions,
a code segment for detecting the positions of the phantom reference structures in the 3D image scanned by the code segment for scanning a 3D phantom,
a code segment for subdividing the 3D image into a plurality of 3D sub-volumes;
a code segment for comparing the detected positions of the reference structures to the known reference positions for each sub-volume,
a code segment for describing each distortion with a local 3D transformation for each sub-volume having distortions existing between known reference and detected positions, and
wherein
said code segment for performing at least one local 3D transformation is configured to correct at least one 3D image that is subsequently imaged with the local 3D transformations from the code segment for describing the distortion with a local 3D transformation.

13. A medical examination apparatus being arranged for implementing the method of claim 1, preferably a medical imaging workstation, configured to receive and process a 3D image, comprising measurement functionality for said 3D image.
